(19) United States
(12) Patent Application Publication
(10) Pub. No.: US 2009/0252840 A1
(43) Pub. Date: Oct. 8, 2009

(54) Equine medication receptacle

(76) Inventor: Brenda C. Thorn, Millville, NJ (US)

Correspondence Address: Hollstein Keating Cattell Johnson & Goldstein PC;Willow Ridge Executive Office Park, Suite 301, 750 Route 73 South, Marlton, NJ, 08053, US

(21) Appl. No.: 12/082,043

(22) Filed: Apr. 7, 2008

(51) Int. Cl. A01K 29/00

(52) U.S. Cl. 426/138

(57) ABSTRACT

An edible receptacle is made of food highly appetizing and tasty to a horse. Optimally, this receptacle will be made out of candy, especially peppermint candy, which is an equine favorite. The receptacle itself can take various forms, but basically consists of a body formed of the candy substance with an outer exterior surface leading into a cavity within the receptacle. Equine medication, in the form of paste-type substances, heavy liquids, pills, or other type of medication, is placed within the cavity such that it is hidden within the receptacle. The horse offered the candied receptacle will readily consume it and, as a result, successfully ingest of both the receptacle and the medication.

### BACKGROUND OF THE INVENTION

Delivering medication for ingestion by animals is not an easy task, especially when the medication has an unpleasant taste. A common method of ensuring that medication is taken involves hiding it in the animal's food. However, many creatures are not fooled by this ploy and they will refuse such offerings. Horses, especially, are quite intelligent and they will reject medication once they become aware of what is being fed to them. Horses will refuse to ingest necessary medicine because it is distasteful. They also recognize the appearance of the medicine and will often react violently when the veterinarian, trainer, or horse owner attempts to administer it to them. Since certain equine medication must be ingested to be truly effective, delivering such medication is problematic.

### SUMMARY OF THE INVENTION

It is thus the object of the current invention to overcome the obstacles and limitations presented by the difficulties of delivering medication to horses.

It is an object of the present invention to provide an easy and simple means for delivering medication for ingestion by horses.

It is an object of the present invention to provide an edible receptacle to house equine medication which a horse will readily ingest without resistance or opposition.

It is still another object of the present invention to provide an edible receptacle which is appetizing to and which will be readily and eagerly consumed by a horse.

These and other objectives are accomplished by the present invention, an edible receptacle made of food highly appetizing and tasty to a horse. Optimally, this receptacle will be made out of candy, especially peppermint candy, which is an equine favorite. The receptacle itself can take various forms, but basically consists of a body formed of the candy substance with an outer exterior surface leading into a cavity within the receptacle. Equine medication, in the form of paste-type substances, heavy liquids, pills or other type of medication, is placed within the cavity such that it is hidden within the receptacle. The horse offered the candied receptacle will readily consume it and, as a result, successfully ingest of both the receptacle and the medication.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows the equine medication receptacle of the present invention.

FIG. 2 shows an alternate embodiment of the equine medication receptacle of the present invention.

FIG. 3 shows a further embodiment of the equine medication receptacle of the present invention.

### DETAILED DESCRIPTION OF THE INVENTION

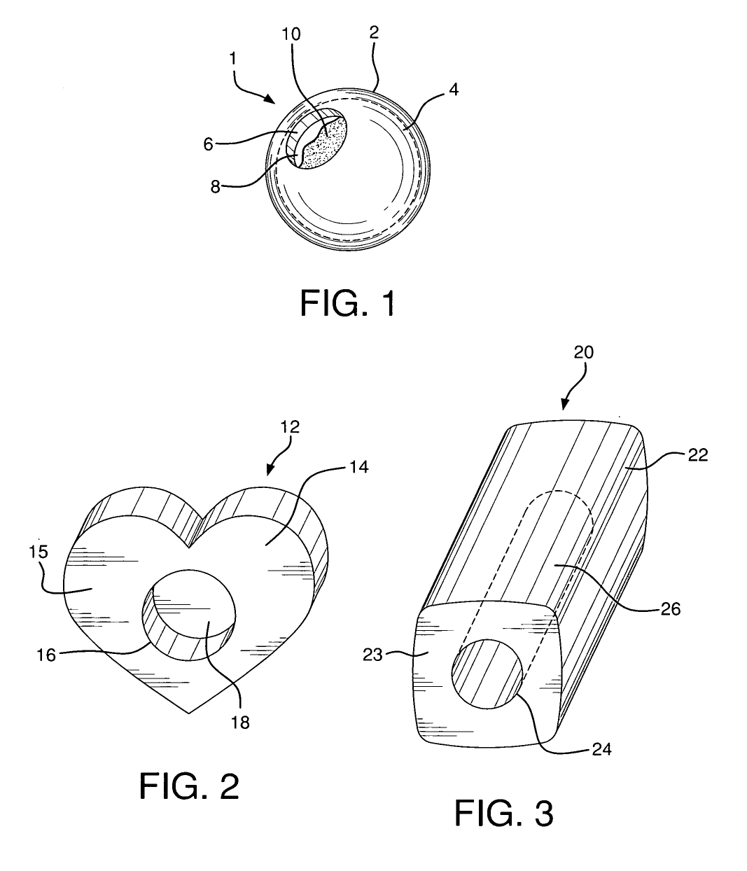

Equine medication receptacle 1 comprises receptacle body 2, shown in FIG. 1, as being shaped like a ball. Body 2 has exterior surface 4 through which opening 6 extends. Space or cavity 8 extends from opening 6 and is located within body 2. Cavity 8 has a shape corresponding to the shape of body 2, for the placement of equine medication 10.

Body 2 is made of a food which is appetizing to a horse. It is anticipated that this food will be candy and, optimally, peppermint candy, a favorite of horses. Since peppermint also provides a strong candy smell, use of this candied substance will further hide the taste of the equine medication and make it even easier to offer and have the receptacle ingested and consumed by the horse.

FIG. 2 shows receptacle 12 with heart shaped body 14 with exterior surface 15, opening 16 and cavity 18. FIG. 3 shows receptacle 20, with rectangularly box-shaped body 22 with exterior surface 23, opening 24 and cavity 26. Once again, equine medication can be placed in cavities 18 and 26, with the bodies of receptacles 12 and 20 being made of peppermint candy or similar equine appetizing food.

Although the equine medication receptacles shown therein have been described as being in the shape of a ball, heart, and rectangularly shaped box, it is contemplated that the receptacle can be configured into any attractive or desired shape, preferably of a size which could be handheld and would be immediately ingested by the horse and consumed in one swallow.

Thus, the equine medication receptacle as described in the present invention provides a ready and simple means to ensure that required medication is delivered directly to the horse without the animal experiencing a distasteful medication or even recognizing that it is being given medicine. Medication administered to the horse in this fashion will be accepted by the animal without resistance or opposition. In addition, the receptacle is configured to accept medication which comes in a variety of forms, e.g. heavy liquid, paste-type, pill, etc.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A receptacle for delivering equine medication to and for consumption by a horse, said receptacle comprising:
a unitary body with an exterior surface, said body being composed of an edible substance appetizing to a horse, the body comprising an opening through the exterior surface leading to cavity means within the body for the placement of equine medication, whereby upon ingestion by the horse of the body and cavity placed medication, the medication is delivered internally to the horse.

2. The receptacle as in claim 1 wherein the substance is candy.

3. The receptacle as in claim 1 wherein the substance is peppermint candy.

4. The receptacle as in claim 1 wherein the body is ball shaped.

5. The receptacle as in claim 1 wherein the body is heart-shaped.

6. The receptacle as in claim 1 wherein the body is a rectangularly shaped box.

7. The receptacle as in claim 1 wherein the cavity means is configured to accept paste-type equine medication.

8. The receptacle as in claim 1 wherein the cavity means is configured to accept heavy liquid equine medication.

9. The receptacle as in claim 1 wherein the cavity means is configured to accept pill equine medication.

10. The receptacle as in claim 1 wherein the cavity means has a shape corresponding to the shape of the body.
